(19) United States
(12) Patent Application Publication
(10) Pub. No.: US 2023/0219433 A1
(43) Pub. Date: Jul. 13, 2023

(54) Isolation Barrier Protection on Multipole Pantographs

(71) Applicant: ABB E-mobility B.V., Delft (NL)

(72) Inventors: Wiebe Zoon, Delft (NL); Gertjan Koolen, Eindhoven (NL); Mariusz Stosur, Imbramowice (PL)

(73) Assignee: ABB E-mobility B.V, Delft (NL)

(21) Appl. No.: 18/153,027

(22) Filed: Jan. 11, 2023

(30) Foreign Application Priority Data
Jan. 11, 2022 (EP) 22150994.6

(51) Int. Cl. B60L 53/14; B60L 53/35

(52) U.S. Cl. CPC B60L 53/14; B60L 53/35; B60L 2200/18

(57) ABSTRACT

A system and method for a pole separating arrangement for a multipole pantograph or a multipole fixed arrangement for charging an electric vehicle includes a first conducting pole arranged on an isolating carrier and configured for contacting a corresponding first pole on the electric vehicle; a second conducting pole arranged on the isolating carrier and configured for contacting a corresponding second pole on the electric vehicle; and an isolating pole separator arranged between the first conducting pole and the second conducting pole. The pole separator has at least one upward pointing arc.

### CROSS-REFERENCE TO RELATED APPLICATIONS

This patent application claims priority to European Patent Application No. 22150994.6, filed on Jan. 11, 2022, which is incorporated herein in its entirety by reference.

### FIELD OF THE DISCLOSURE

The present disclosure relates to the field of electric vehicle charging infrastructure, particularly for large vehicles, e.g. busses or trucks, which are charged via a pantograph.

### BACKGROUND OF THE INVENTION

For a so-called “opportunity charging,” e.g. of electric busses, in at least some cases a multipole pantograph is used. The pantograph may be mounted on an overhead system comprising a stationary pole. As an alternative, the pantograph may be arranged on the bus, going upwards to the overhead fixed arrangement. To use this system, a bus may be placed underneath the pantograph, and after the bus being positioned correctly, the pantograph may move down (or up, in the alternative) to connect with electrical contacts on the roof of the bus, for initiating a charging process. This pantograph-based system is in many cases positioned outdoor, and thus exposed to weather, e.g., to rain. Hence, measures for improving an electric isolation between the pantograph's poles may be useful.

### BRIEF SUMMARY OF THE INVENTION

In a general aspect, the present disclosure describes an improved electric isolation between the pantograph's poles. More specifically, a disclosed embodiment relates to a pole separating arrangement for a multipole pantograph or a multipole fixed arrangement for charging an electric vehicle, the pole separating arrangement comprising: a first conducting pole, arranged on an isolating carrier and configured for contacting a corresponding first pole on the electric bus; a second conducting pole, arranged on the isolating carrier and configured for contacting a corresponding second pole on the electric bus; and an isolating pole separator, arranged between the first conducting pole and the second conducting pole, wherein the pole separator has at least one upward pointing arc.

A multipole pantograph in accordance with the disclosure may comprise a plurality of so-called poles, i.e. contacts that are used for charging. For instance, the poles may comprise connections for DC+, for DC−, for Protected Earth (PE) or another ground line, and a signal line, which may, e.g., control the charging process, which may comprise a communication and safety verification process. The poles are arranged on a pantograph, e.g. to make sure that the poles are kept essentially horizontal when moving down to connect with electrical contacts on the roof of the vehicle. As an alternative, the pantograph may be arranged on the bus, so that the poles are kept essentially horizontal when moving up to connect with electrical contacts on an overhead multipole fixed arrangement—sometimes called “hood”—, which is configured for delivering the charging power. In this case, the features of the multipole pantograph may be applied to the multipole fixed arrangement. The vehicle may be a bus, a truck, and/or another vehicle that is configured for carrying corresponding poles to the pantograph's poles, e.g. on its roof. Furthermore, the vehicle needs to be compatible with respect to electrical and further aspects, e.g. to support an adequate charging protocol.

At least two of the poles (a first and a second conducting pole) may be arranged on one bar, e.g. an electrically isolating bar or carrier, on which at least two electrically conducting poles—e.g. in form of rails—are mounted. Humidity, e.g. caused by rain, snow, etc., may lead to electric creepage between the poles. To prevent, or at least reduce the creepage, an isolating pole separator is arranged between the first and the second conducting pole. The pole separator has at least one upward pointing arc. The upward pointing arc may be of any form, e.g. a kind of an upside down “V” or “U”, a sine, or of a similar form. The pole separator may have the same width (or a different width) as the isolating carrier. This may depend on mechanical restrictions.

### BRIEF DESCRIPTION OF THE SEVERAL VIEWS OF THE DRAWING(S)

FIG. 1 is a picture of a part of a multipole pantograph in accordance with the disclosure.

Each of FIG. 2a, FIG. 2b, and FIG. 2c is a schematic cross-section variations of an isolating mounting element according to an embodiment of the present disclosure.

FIG. 3 is a diagram that schematically illustrates an isolating pole separator according to an embodiment of the present disclosure.

### DETAILED DESCRIPTION OF THE INVENTION

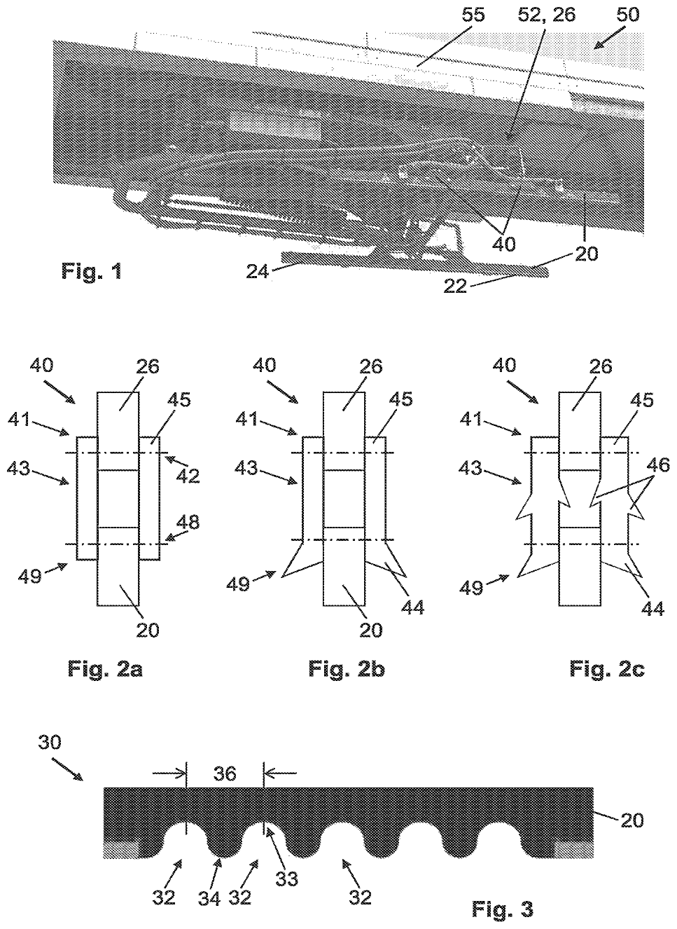

FIG. 1 shows a picture of a part of a multipole pantograph 50, which comprises a pole separating arrangement 10. The pantograph 50 is shown in a retracted position. For charging, the pantograph may move down to connect with electrical contacts on the roof of a vehicle for initiating a charging process. The shown pantograph 50 is mounted on a roof 55 of white colour. A part of a chassis 52 of the pantograph 50 visible. The chassis 52 comprises a third conducting pole 26. On the third conducting pole 26, two isolating carriers 20 are mounted, by means of an isolating mounting element 40. Each one of the two isolating carriers 20 has a first conducting pole 22 and a second conducting pole 24, which are arranged on the isolating carrier 20 (reference signs 22, 24 only on one of the isolating carriers 20). The poles 22, 24 are configured for contacting a corresponding second pole on an electric vehicle (not shown). Between the poles 22, 24, an isolating pole separator 30 is arranged.

FIGS. 2a, 2b, 2c show schematically cross-section variations of an isolating mounting element 40. FIG. 2a shows schematically an isolating mounting element 40, which combines a part of a third conducting pole 26 with a part of an isolating carrier 20 (see FIG. 1). The mounting element 40 comprises two brackets 45, which are mounted on the third conducting pole 26 and the isolating carrier 20, by means of an upper screw 42 and a lower screw 48, respectively. The brackets 45 have each an upper edge 41, a mid portion 43, and a lower edge 49. Identical reference signs like in FIG. 2a shown on FIGS. 2b and 2c show the same or similar parts.

FIG. 2b shows schematically an isolating mounting element 40 with a downward pointing protrusion 44 on the lower edge 49 of each of the brackets 45. The protrusions 44 may be formed in one piece with the bracket 45, or as an additional element. FIG. 2c shows schematically an isolating mounting element 40 with a downward pointing protrusion 44 on the lower edge 49 of each of the brackets 45 and a further downward pointing protrusion 46 on the mid portion 43. The further downward pointing protrusions 46 may be arranged only on an outside of the brackets 45, or both on an inside and on the outside (as shown in FIG. 2c).

FIG. 3 shows schematically an isolating pole separator 30 according to an embodiment. The isolating pole separator 30 is configured for being arranged on an isolating carrier 20, between a first conducting pole 22 and a second conducting pole 24 (see FIG. 1). The isolating pole separator 30 shown in FIG. 3 has a plurality of upward pointing arcs 32. Between each two of the arcs 32, a downward pointing arc 34 is arranged. The plurality of upward pointing arcs may, on the one hand, contribute to a higher electrical resistance between the first conducting pole 22 and the second conducting pole 24 and to a better electrical separation between the poles 22, 24, even in dry weather. In addition, the isolating pole separator 30 may bring further benefits in wet weather, because droplets may be led down to the downward pointing arcs 34, thus keeping the upward pointing arcs 32 dry. A distance 36 between vertices 33 of the upward pointing arcs 32 may be between 1 cm and 10 cm, preferably between 2 cm and 5 cm.

The pole separator brings a lot of benefits. For instance, it prolongs a surface-distance between the poles. Thus, an electrical resistance between the poles is increased, even in dry weather. Moreover, in wet weather, humidity, e.g. in form of drops, may be led downward by the upward pointing arc. These effects may be more effective when the pole separator has or comprises a plurality of upward pointing arcs.

In various embodiments, the upward pointing arc is formed as a triangle, a rectangle, a segment of a circle, as a sine and/or as a sinusoidal curve. An example for the segment of a circle may be a half circle. The selection of one of these forms may depend on an ease of manufacturing, stability considerations—e.g. to avoid a predetermined breaking point—and/or further aspects.

In various embodiments, the pole separator has or comprises a plurality of upward pointing arcs. The plurality of upward pointing arcs may advantageously contribute to a better electrical separation between the poles and/or to a higher electrical resistance between them.

In various embodiments, each two vertices of the upward pointing arcs have a distance between 1 cm and 10 cm, preferably between 2 cm and 5 cm. These distances turned out to be particularly advantageous, e.g. in regards to manufacturing and/or behaviour in wet weather.

In some embodiments, the isolating pole separator is formed in one piece with the isolating carrier. The may be particularly advantageous with regard to manufacturing and/or storage costs.

In various embodiments, the pole separating arrangement further comprises a third conducting pole that is arranged above the isolating carrier.

The third conducting pole may be a chassis or a part of the chassis, which may mechanically connect the “scissor-like” part of the pantograph with the isolating carrier, on which to poles are mounted. The isolating mounting element may thus connect third conducting pole with the isolating carrier. The third conducting pole may be connected to protected earth, PE, or another electric ground.

In various embodiments, the pole separating arrangement further comprises an isolating mounting element, arranged between the third conducting pole and the isolating carrier. The isolating mounting element comprises a bracket, configured for mechanically connecting the third conducting pole with the isolating carrier, wherein the bracket comprises a downward pointing protrusion.

The isolating mounting element may, besides the bracket, further comprise mounting means, such as screws, rivets, or the like. However, there may be further mounting means, for example for a positive-locking, force-locking, or a firmly bonded connection between the bracket, the third conducting pole, and the isolating carrier. The bracket comprises a downward pointing protrusion, and/or the downward pointing protrusion is mounted on the bracket.

This may advantageously prevent humidity—e.g. rain drops or droplets—from forming a continuous path between the third conducting pole and the isolating carrier, which carries the poles. This may be achieved by the downward pointing protrusion, because, by this, they have a defined point where they can glide off. The downward pointing protrusion may, e.g., be formed as a flared out section, e.g. on a bottom or a lower edge of the bracket. For further preventing that the droplets do not accumulate towards the sides, the flared out section may be lower in the middle and taper up towards the edges.

In some embodiments, the downward pointing protrusion is arranged horizontally along a lower edge of the bracket. The downward pointing protrusion may cover at least a part of the lower edge of the bracket. The downward pointing protrusion may be slightly inclined, e.g., to move the droplets to one corner. Said features may advantageously contribute to bring the droplets away from the pantograph and/or its parts.

In some embodiments, the pole separating arrangement further comprises a further downward pointing protrusion that is arranged horizontally along a mid portion of the bracket. Optionally, multiple of these “barriers” (the downward pointing protrusions) may be introduced on this bracket. Said “barriers” may not only contribute to bring the droplets away from the pantograph and/or its parts, but they may further contribute to prolong a surface-distance between the poles, thus increasing an electrical resistance between the parts, even in dry weather.

In various embodiments, the downward pointing protrusion and/or the further downward pointing protrusion has an outer angle of more than 90° and an inner angle of less than 90°. This may advantageously contribute to make the above-mentioned benefits particularly effective.

In various embodiments, the third conducting pole is configured for a connection to a ground contact, particularly to protected earth, PE. This may advantageously contribute to have good electrical conditions, particularly a high safety at the pantograph.

An aspect relates to a use of a pole separating arrangement as described above and/or below for protecting conducting poles from an electric creepage path between the poles of a multipole pantograph. The creepage between the poles may, for instance, be caused by rain or another kind of humidity, possibly in combination with conducting particles in the air, e.g. pollution. This may bring a risk for reduced resistance between the poles, which may be prevented, at least partly, by the pole separating arrangement described above and/or below.

### LIST OF REFERENCE SYMBOLS

10 pole separating arrangement
20 isolating carrier
22 first conducting pole
24 second conducting pole
26 third conducting pole
30 isolating pole separator
32 upward pointing arc
33 vertex
34 downward pointing arc
36 distance
40 isolating mounting element
41 upper edge
42 upper screw
43 mid portion
44 downward pointing protrusion
45 bracket
46 further downward pointing protrusion
48 lower screw
49 lower edge
50 multipole pantograph
52 chassis
55 roof

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A pole separating arrangement for a multipole arrangement for charging an electric vehicle, the pole separating arrangement comprising:
a first conducting pole arranged on an isolating carrier and configured for contacting a corresponding first pole on the electric vehicle;
a second conducting pole arranged on the isolating carrier and configured for contacting a corresponding second pole on the electric vehicle; and
an isolating pole separator arranged between the first conducting pole and the second conducting pole;
wherein the pole separator has at least one upward pointing arc.

2. The pole separating arrangement of claim 1, wherein the upward pointing arc is formed as one of a triangle, a rectangle, a segment of a circle, a sine, or a sinusoidal curve.

3. The pole separating arrangement of claim 1, wherein the pole separator further includes a plurality of upward pointing arcs.

4. The pole separating arrangement of claim 3, wherein two vertices of the upward pointing arcs have a distance between 1 cm and 10 cm.

5. The pole separating arrangement of claim 1, wherein the isolating pole separator is formed in one piece with the isolating carrier.

6. The pole separating arrangement of claim 1, further comprising a third conducting pole arranged above the isolating carrier.

7. The pole separating arrangement of claim 6, further comprising an isolating mounting element arranged between the third conducting pole and the isolating carrier, the isolating mounting element comprising a bracket configured for mechanically connecting the third conducting pole with the isolating carrier, wherein the bracket comprises a downward pointing protrusion.

8. The pole separating arrangement of claim 7, wherein the downward pointing protrusion is arranged horizontally along a lower edge of the bracket.

9. The pole separating arrangement of claim 7, further comprising a further downward pointing protrusion that is arranged horizontally along a mid portion of the bracket.

10. The pole separating arrangement of claim 7, wherein the downward pointing protrusion has an outer angle of more than 90° and an inner angle of less than 90°.

11. The pole separating arrangement of claim 9, wherein the further downward pointing protrusion has an outer angle of more than 90° and an inner angle of less than 90°.

12. The pole separating arrangement of claim 6, wherein the third conducting pole is configured for a connection to a ground contact.
